(19) United States
(12) Patent Application Publication
(10) Pub. No.: US 2012/0150650 A1
(43) Pub. Date: Jun. 14, 2012

(54) AUTOMATIC ADVERTISEMENT GENERATION BASED ON USER EXPRESSED MARKETING TERMS

(75) Inventor: Brannon Zahand, Maple Valley, WA (US)

(73) Assignee: MICROSOFT CORPORATION, Redmond, WA (US)

(21) Appl. No.: 12/963,348

(22) Filed: Dec. 8, 2010

(51) Int. Cl. G06Q 30/00

(52) U.S. Cl. 705/14.58; 705/14.49; 705/14.66

(57) ABSTRACT

Generation of an advertisement for one or more users based on user expression of a marketing term captured while viewing multimedia content is described. A marketing term is one or more words linked to a product or service. Marketing terms are downloaded to a computer system which is communicatively coupled to an audiovisual capture device to capture image and audio data of users viewing or interacting with multimedia content. The one or more users are identified via the capture data, and a count of the number of instances a marketing term is expressed is updated. The count is part of term context data such as demographic data from user profile data. The term context data is transmitted to a remote computer system for marketing analysis. An advertisement is selected for communication to a designated user based on the term context data.

### BACKGROUND

With the advent of audiovisual capture technologies to recognize and utilize a user's actions to control applications (e.g. video games, media players, etc.), opportunities are presented to record speech and actions of a user for marketing purposes. However, privacy concerns discourage the recording and transmission of captured audiovisual data of the user without explicit consent of the user, which may prevent the use of this data for various purposes including marketing.

### SUMMARY

The technology provides various embodiments for generating an advertisement for one or more users based on user expression of a marketing term. In one or more method embodiments, one or more users viewing multimedia content on a display communicatively coupled to a computer system are identified. A marketing term expressed by the one or more users is detected in live capture data from an audiovisual capture device communicatively coupled to the computer system, and term context data is updated to include a count of the number of times the marketing term has been expressed by the one or more users. The term context data including the count may be transmitted to a remote computer system, and an advertisement is identified based on the term context data for communication to one or more designated users. The advertisement is communicated to the one or more designated users.

One or more embodiments of a system for generating an advertisement for one or more users based on user expression of a marketing term are also described comprising an audio input device communicatively coupled to a multimedia computer system to receive live audio signals from the one or more users in the vicinity of the audio device. The vicinity of the audio device is a location where the one or more users has an expectation of privacy. An example of such a location is a private residence. The multimedia computer system is communicatively coupled to a remote computer system for receiving one or more marketing terms from the remote system and for sending term context data to the remote computer system. The multimedia computer system stores one or more marketing terms and a user profile for each respective user of a multimedia application. Speech recognition software stored in a memory of the computer system receives audio stream data of the live audio signals and identifies whether the one or more marketing terms have been spoken in the audio stream data. Software executing on a processor of the multimedia computer system updates term context data including a count for each marketing term of the number of times the term was spoken during execution of a multimedia application. In other embodiments, the expression of the marketing term may be detected in culturally-contextual body gestures and/or sign language gestures. The processor causes display of an advertisement based on the term context data.

Embodiments of one or more computer storage media having stored thereon instructions which when executed by a processor cause the processor to perform a method for generating an advertisement for one or more users based on user expression of a marketing term are also described.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example embodiment of a target recognition, analysis, and tracking system.

FIG. 2A illustrates one embodiment of a capture device and a computing system in which embodiments of the technology may operate.

FIG. 2B illustrates one embodiment of a gesture recognition engine including a sign language interpreter in which embodiments of the technology may operate.

FIG. 3A illustrates an example of a computing system that may be used to implement the computing system of FIGS. 1-2B.

FIG. 3B illustrates an example of a general purpose computing system in which embodiments of the technology may operate.

FIG. 4 is a flowchart describing one embodiment of a method for generating an advertisement for one or more users based on user expression of a marketing term captured while viewing multimedia content.

FIG. 5A is a flowchart describing one embodiment of an implementation process for detecting a marketing term expressed by the one or more users in live capture data.

FIG. 5B is a flowchart describing one embodiment of another implementation process for detecting a marketing term expressed by the one or more users in live capture data.

FIG. 6 is a flowchart describing one embodiment of an implementation process for updating term context data for a detected term.

FIG. 7A is a flowchart describing one embodiment of an implementation process for identifying an advertisement for communication to at least one user based on the term context data.

FIG. 7B is a flowchart describing another embodiment of an implementation process for identifying an advertisement for communication to at least one user based on the term context data.

FIG. 8A is a flowchart describing one embodiment of an implementation process for communicating an advertisement to a designated user.

FIG. 8B is a flowchart describing another embodiment of an implementation process for communicating an advertisement to a designated user.

FIGS. 9A through 9D illustrate examples of skeletal tracking models for a user.

### DETAILED DESCRIPTION

The technology provides embodiments for generating an advertisement for one or more users based on user expression of a marketing term captured while viewing multimedia content. A marketing term is one or more words. Advertising or marketing terms are downloaded to a computer system which is communicatively coupled to an audiovisual capture device to capture image and audio data of users viewing or interacting with multimedia content generated by an application. For example, a gaming console computer system with a natural user interface (NUI) in which the user's movements control action in the multimedia content is an example of such a computer system communicatively coupled to an audiovisual capture device and an audiovisual display.

Another example of such a computer system communicatively coupled to an audiovisual capture device and an audiovisual display is one or more remote servers communicating with a local computer system which is communicatively coupled to an audiovisual capture device and display in the vicinity of the user. The local capture device can send live audio stream data and/or live image data to the remote server system for processing by software on the one or more servers to detect marketing terms. An example of such a remote server system may be an online gaming service or other content provider which provides connection services for remote users to play together. The gaming service or content provider may also provide other services like live chat, e-mail, and instant messaging for remote users communicating through their local game console computers. The remote server system may also be executing, at least in part, a multimedia application displayed for participating remote users on their local displays of their local computers.

Often a user viewing multimedia content is doing so in a vicinity of an audiovisual capture device in which the user has an expectation of privacy that someone is not listening to his or her conversation unknown to the user. A residence is an example of such a vicinity. Privacy policies and legal restrictions generally prevent recording audiovisual data of users, and in particular transmission of such audiovisual data, to third parties without the authorization of the user. The technology provides a solution for selection of an advertisement to be targeted at one or more users based on his or her expressions of speech without making unauthorized transmissions of such expressions. An expression of speech may be a vocal pronunciation of a marketing term, for example a title of a movie, or one or more gestures representing the marketing term. For example, an action such as drinking may be defined as a gesture which may be associated with “drink” as a marketing term for example. In another example, a sign of a standardized sign language may be a gesture which expresses a marketing term. A sign language is a language which uses visually transmitted gestures or signs to convey meaning. This may include one or more of, simultaneous combinations of hand shapes, orientation and movement of the hands, arms or body, and facial expressions to express a speaker's thoughts.

In some embodiments of a method, one or more users viewing the multimedia content on a display communicatively coupled to a computer system are identified and a marketing term expressed by the one or more users is detected in live capture data from an audiovisual capture device communicatively coupled to the computer system. For example, streaming audio data may be analyzed for passively recognizing a marketing term. The recognition may be considered passive in that the user is not questioned or prompted about the particular term but expresses the term in the course of speech the user initiates and controls. The audio data may be temporarily buffered but it is not recorded in non-volatile memory for later transmission in violation of a privacy policy.

Term context data including a count of the number of times the marketing term has been expressed by the one or more users is stored and may be transmitted, at least in part, to a remote computer system. An advertisement based on the term context data is identified for communication to one or more designated users. This identification step may be performed by the computer system located in the vicinity of the audiovisual capture device or at a remote computer system. The term context data can also comprise time stamps of when each term is expressed although the transmitted version may include lengths of intervals between expressions of the term to further protect anonymity. Other examples of data the term context data may include are the identity of the user who expressed the term, the identity of other users present when the term was expressed, which application was executing, as well as demographic data from user profile data for the one or more users present or who are associated with a present user. For example, demographic data for users in a user's friend list may be part of the term context data.

The transmitted term context data may be non-identifying demographic data such as for example age group, gender, self assigned gamer category and games played. In other examples, the remote computer system may be associated with a gaming or multimedia service and has access already to identifying user profile data. This remote service computer system may perform some of the actions described, particularly those involving displaying or sending ads to users at different geographic locations. The remote service computer system also may be an interface with a third party remote computer system which provides the advertisements tied to the marketing terms.

The identified advertisement is communicated to the one or more designated users. In some examples, the advertisement is displayed in the context of the executing multimedia application. For example, a user is playing a game with other users at his residence. The location may be determined by the contact data in his user profile and the IP address of his computer system in the user profile data. The user may have said the marketing term “pizza”, and in the same session of the game, an advertisement for a local pizza place appears in a billboard in a scene of the game they are playing. In other examples, the advertisement may be communicated to the one or more designated users via other forms of communication outside the executing application. For example, an advertising application executing on the user's local computer or a server of the gaming service may send an e-mail to the user or users in the user's friends list advertising a sale price for a book which was being discussed during a gaming session.

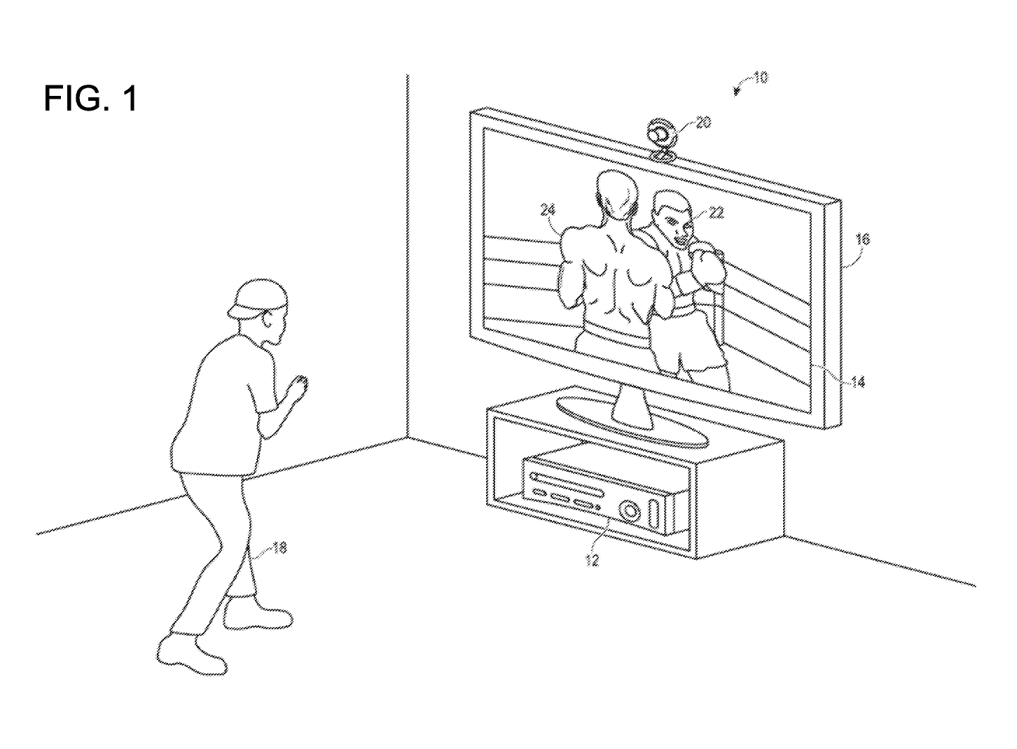

FIG. 1 provides a contextual example in which the present technology can be useful. FIG. 1 illustrates an example embodiment of a target recognition, analysis, and tracking system. The target recognition, analysis, and tracking system 10 may be used to recognize, analyze, and/or track a human target such as the user 18. Embodiments of the target recognition, analysis, and tracking system 10 include a computing environment 12 for executing a gaming or other multimedia application, and an audiovisual device 16 for providing audio and visual representations from the gaming or other multimedia application. The system 10 further includes a capture device 20 for capturing positions and movements performed by the user in three dimensions (3D), which the computing environment 12 receives, interprets and uses to control the gaming or other application.

Embodiments of the computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes one or more capture devices 20 for capturing image data relating to one or more users and/or objects sensed by the capture device. In embodiments, the capture device 20 may be used to capture information relating to movements and gestures of one or more users, which information is received by the computing environment and used to render, interact with and/or control aspects of a gaming or other multimedia application. Examples of the computing environment 12 and capture device 20 are explained in greater detail below.

Embodiments of the target recognition, analysis, and tracking system 10 may be connected to an audiovisual device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audiovisual signals associated with the game or other multimedia application. The audiovisual device 16 may receive the audiovisual signals from the computing environment 12 and may then output the game or multimedia application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, a component video cable, a DisplayPort compatible cable or the like.

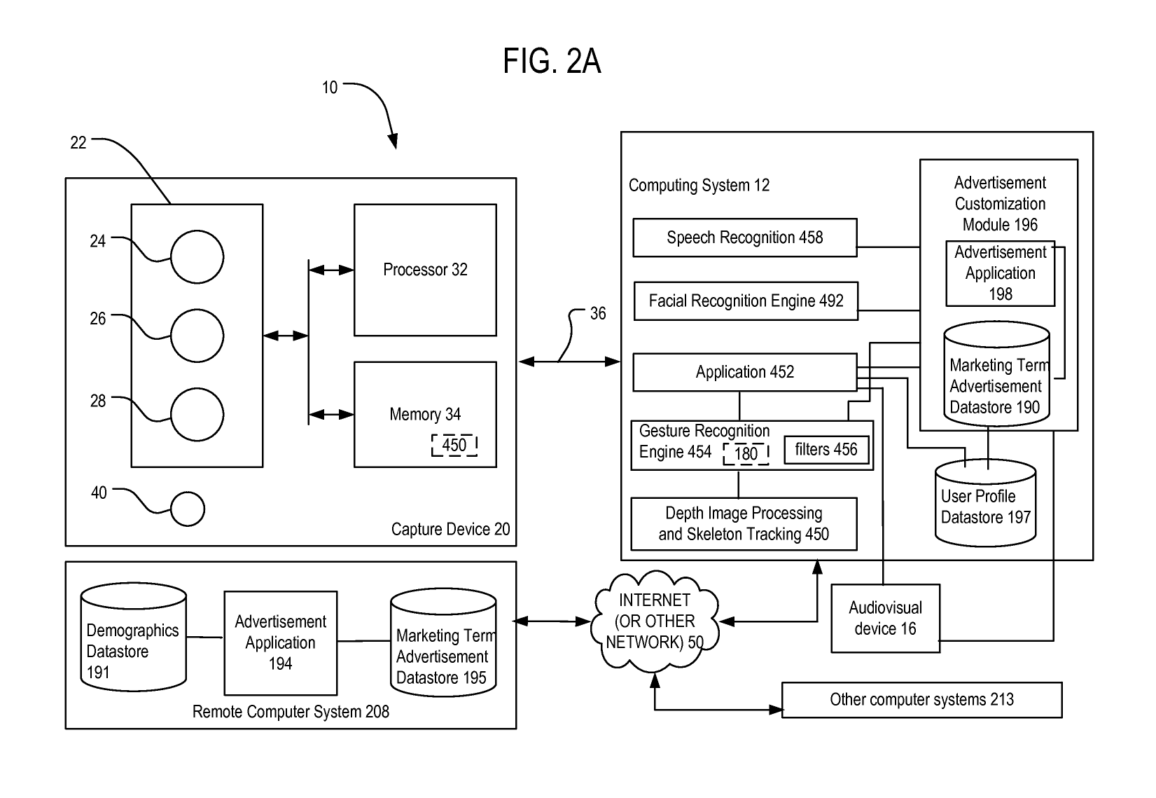

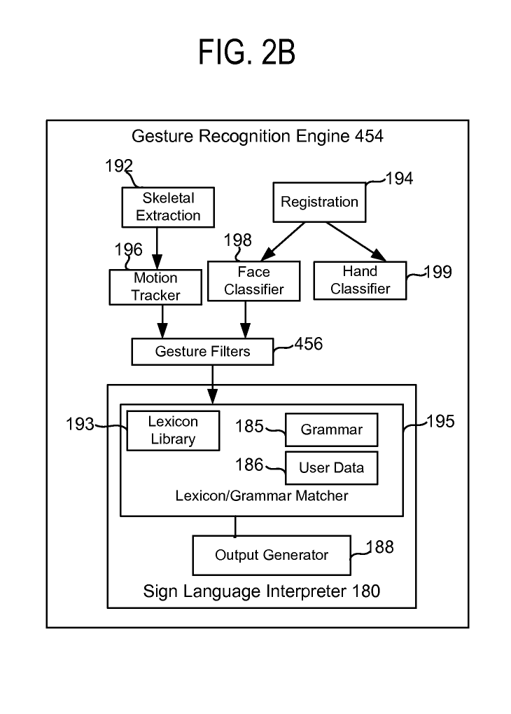

In an example embodiment, the application executing on the computing environment 12 may be a game with real time interaction such as a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, the user 18 may throw a punch in physical space to cause the player avatar 24 to throw a punch in game space. Thus, according to an example embodiment, the capture device 20 captures a 3D representation of the punch in physical space using the technology described herein. A processor (see FIG. 2A) in the capture device 20 and the computing environment 12 of the target recognition, analysis, and tracking system 10 may be used to recognize and analyze the punch of the user 18 in physical space such that the punch may be interpreted as a gesture or game control of the player avatar 24 in game space and in real time.

Multimedia content which may be displayed on audiovisual device 16 can include any type of audio, video, and/or image media content received from media content sources such as content providers, broadband, satellite and cable companies, advertising agencies the internet or video streams from a web server. As described herein, multimedia content can include recorded video content, video-on-demand content, television content, television programs, advertisements, commercials, music, movies, video clips, and other on-demand media content. Other multimedia content can include interactive games, network-based applications, and any other content or data (e.g., program guide application data, user interface data, advertising content, closed captions, content metadata, search results and/or recommendations, etc.).

In the figures below, certain modules, datastores and the like are referenced. The particular naming and division of modules, routines, features, attributes, methodologies and other aspects are not mandatory, and the mechanisms that implement the technology or its features may have different names, divisions and/or formats.

FIG. 2A illustrates one embodiment of a capture device 20 and computing system 12 that may be used in the target recognition, analysis and tracking system 10 to recognize human and non-human targets in a capture area and uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight.

As shown in FIG. 2A, the capture device 20 may include an image camera component 22. According to one embodiment, the image camera component 22 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2A, the image camera component 22 may include an IR light component 24, a three-dimensional (3-D) camera 26, and an RGB camera 28 that may be used to capture the depth image of a capture area. For example, in time-of-flight analysis, the IR light component 24 of the capture device 20 may emit an infrared light onto the capture area and may then use sensors to detect the backscattered light from the surface of one or more targets and objects in the capture area using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light component 24. Upon striking the surface of one or more targets or objects in the capture area, the pattern may become deformed in response. Such a deformation of the pattern may be captured by, for example, the 3-D camera 26 and/or the RGB camera 28 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing system 12 in the target recognition, analysis and tracking system 10. Additionally, the microphone 40 may be used to receive audio signals provided by the user. The audio signals may include vocal speech including one or more marketing terms. The audio signals may also include commands to control an application 452 such as a game application or a non-game application, or the like that may be executed by the computing system 12.

In one embodiment, capture device 20 may further include a processor 32 that may be in operative communication with the image camera component 22. The processor 32 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, user profiles or any other suitable information, images, or the like. According to one example, the memory component 34 may include random access memory (RAM), read only memory (ROM), cache, Flash memory, a hard disk, or any other suitable storage component. As shown in FIG. 2A, the memory component 34 may be a separate component in communication with the image capture component 22 and the processor 32. In another embodiment, the memory component 34 may be integrated into the processor 32 and/or the image capture component 22. In one embodiment, some or all of the components 22, 24, 26, 28, 40, 32 and 34 of the capture device 20 illustrated in FIG. 2A are housed in a single housing. The memory 34 may also include a version of software 450 which may work with software 450 executing in the computing system 12 for performing depth image processing and skeleton model tracking as described further below.

The capture device 20 may be in communication with the computing system 12 via a communication link 36. The communication link 36 may be a wired connection including, for example, a USB connection, a Firewire connection, an Ethernet cable connection, or the like and/or a wireless connection such as a wireless 802.11b, g, a, or n connection. The computing system 12 may provide a clock to the capture device 20 that may be used to determine when to capture, for example, a scene via the communication link 36.

The capture device 20 may provide the depth information and images captured by, for example, the 3-D (or depth) camera 26 and/or the RGB camera 28, including a skeletal model that may be generated by the capture device 20, to the computing system 12 via the communication link 36. As used herein, the computing system 12 may refer to a single computing device or to a computing system of more than one computing device. The computing system 12 may include non-computing components as well.

Depth image processing and skeletal tracking module 450 uses the depth images to track one or more persons detectable by the depth camera function of capture device 20. Depth image processing and skeletal tracking module 450 provides the tracking information to application 452, which can be a video game, productivity application, communications application or other software application etc. The audio data and visual image data is also provided to application 452 and depth image processing and skeletal tracking module 450. Application 452 provides the tracking information, audio data and visual image data to the gesture recognition engine 454. In another embodiment, the gesture recognition engine 454 receives the tracking information directly from depth image processing and skeletal tracking module 450 and receives the audio data and visual image data directly from capture devices 20.

The gesture recognition engine 454 is associated with a collection of filters 456 each comprising information concerning a gesture which is an action or pose that may be performed by any person or object detectable by capture device 20. A gesture may be dynamic, comprising a motion, such as mimicking throwing a ball. A gesture may be a static pose, such as holding one's crossed forearms in front of his torso. A gesture may also incorporate props, such as by swinging a mock sword. A gesture may comprise more than one body part, such as clapping the hands together, or a subtler motion, such as pursing one's lips.

In particular, a gesture may also be an action or pose which is an expression of speech, in particular an expression of a marketing term. A gesture may be used for controlling the action or execution of an application. Gestures may be used for input in a general computing context. For instance, various motions of the hands or other body parts may correspond to common system wide tasks such as navigate up or down in a hierarchical menu structure, scroll items in a menu list, open a file, close a file, and save a file. Gestures may also be used in a video-game-specific context, depending on the game. For instance, with a driving game, various motions of the hands and feet may correspond to steering a vehicle in a direction, shifting gears, accelerating, and breaking.

A gesture may be associated with a set of default parameters that an application or operating system may override with its own parameters. In this scenario, an application is not forced to provide parameters, but may instead use a set of default parameters that allow the gesture to be recognized in the absence of application-defined parameters.

For example, the data from capture device 20 may be processed by filters 456 to identify when a user or group of users has performed one or more gestures or other actions. Those gestures may be associated with various controls, objects or conditions of application 452. Thus, computing system 12 may use the gesture recognition engine 454, with the filters 456, to track and interpret and movement of objects (including people). Additionally, an application may also implement its own additional filters via an interface with the gesture recognition engine 454.

The filters 456 may include gestures which are expressions of marketing terms such as signs of a sign language, culturally contextual body gestures or defined actions which may be detected as gestures expressive of a marketing term as in the drinking example. An example of a culturally contextual gesture is putting a hand near the mouth, the position of the hand being as if (but not actually) holding a drinking container (e.g. cup, glass, can, bottle, etc.) and moving the hand to and from the mouth for a predetermined number of times. In this example of FIG. 2A, the gesture recognition engine 454 may optionally include a sign language interpreter 180 which may be used in recognizing sign gestures of a sign language, for example American Sign Language (ASL). An embodiment the engine 454 with a sign language interpreter 180 is described in FIG. 2B below.

One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 Application), incorporated herein by reference in its entirety. The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for tracking can also be used. Suitable tracking technologies are also disclosed in the following four U.S. Patent Applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

More information about embodiments of the gesture recognition engine 454 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009. Both of which are incorporated by reference herein in their entirety.

More details on embodiments for recognizing gestures is now provided. The target recognition, analysis and tracking system 10 may determine whether the depth image includes a human target. In one embodiment, the edges of each target such as the human target and the non-human targets in the captured scene of the depth image may be determined for example by the depth image processing and skeleton tracking 450. In other embodiments, some of the depth image processing and skeleton tracking tasks may optionally be shared with software 450 executing on processor 32. As described above, each of the depth values may represent a depth value such as a length or distance in, for example, centimeters, millimeters, or the like of an object in the captured scene from the capture device 20. According to an example embodiment, the edges may be determined by comparing various depth values associated with, for example, adjacent or nearby pixels of the depth image. If the various depth values being compared are greater than a predetermined edge tolerance, the pixels may define an edge.

According to another embodiment, predetermined points or areas on the depth image may be flood filled to determine whether the depth image includes a human target. For example, various depth values of pixels in a selected area or point of the depth image may be compared to determine edges that may define targets or objects as described above. In an example embodiment, the predetermined points or areas may be evenly distributed across the depth image. For example, the predetermined points or areas may include a point or an area in the center of the depth image, two points or areas in between the left edge and the center of the depth image, two points or areas between the right edge and the center of the depth image, or the like.

The Z values of the Z layers may be flood filled based on the determined edges. For example, the pixels associated with the determined edges and the pixels of the area within the determined edges may be associated with each other to define a target or an object in the capture area that may be compared with a pattern.

According to an example embodiment, each of the flood-filled targets, human and non-human may be matched against a pattern to determine whether and/or which of the targets in the capture area include a human. The pattern may include, for example, a machine representation of a predetermined body model associated with a human in various positions or poses such as a typical standing pose with arms to each side.

In an example embodiment, the human target may be isolated and a bitmask of the human target may be created to scan for one or more body parts by the depth image processing and skeleton tracking software 450. For example, after a valid human target is found within the depth image, the background or the area of the depth image not matching the human target can be removed. A bitmask may then be generated for the human target that may include values of the human target along, for example, an X, Y, and Z axis. According to an example embodiment, the bitmask of the human target may be scanned for various body parts, starting with, for example, the head to generate a model of the human target. The top of the bitmask may be associated with a location of the top of the head. After determining the top of the head, the bitmask may be scanned downward to then determine a location of a neck, a location of shoulders, and the like. The depth map or depth image data can be updated to include a probability that a pixel is associated with a particular virtual body part in the model.

According to an example embodiment, upon determining the values of a body part, a data structure may be created that may include measurement values such as length, width, or the like of the body part associated with the bitmask of the human target. In one embodiment, the data structure for the body part may include results averaged from a plurality of depth images captured in frames by the capture device 20 at a frame rate. The model may be iteratively adjusted at a certain number of frames. According to another embodiment, the measurement values of the determined body parts may be adjusted such as scaled up, scaled down, or the like such that measurements values in the data structure more closely correspond to a typical model of a human body. A body model may contain any number of body parts, each of which may be any machine-understandable representation of the corresponding part of the modeled target.

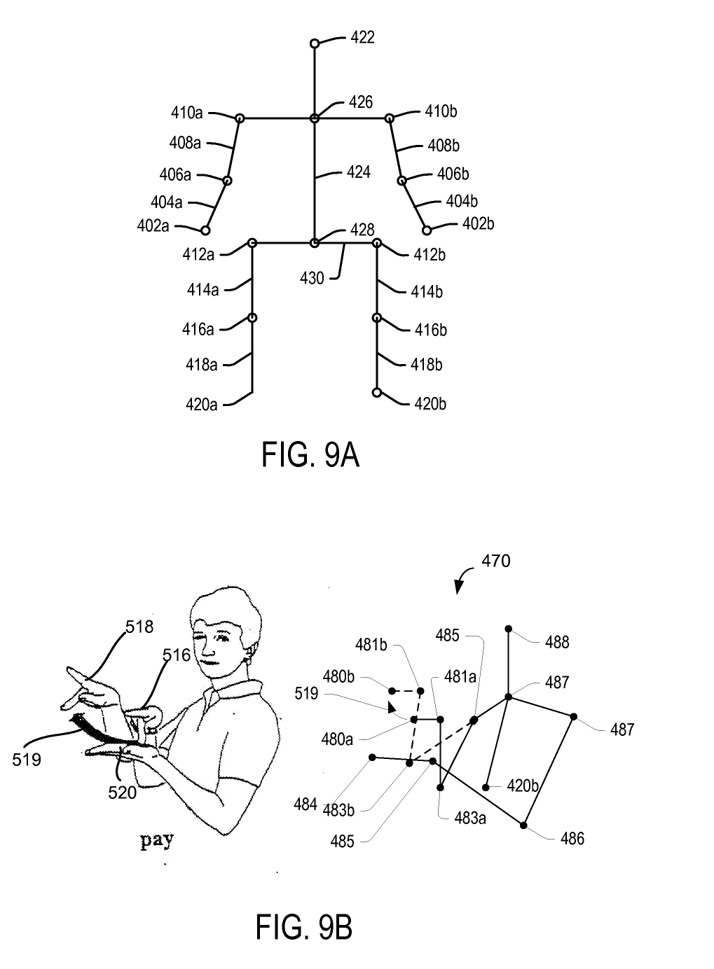

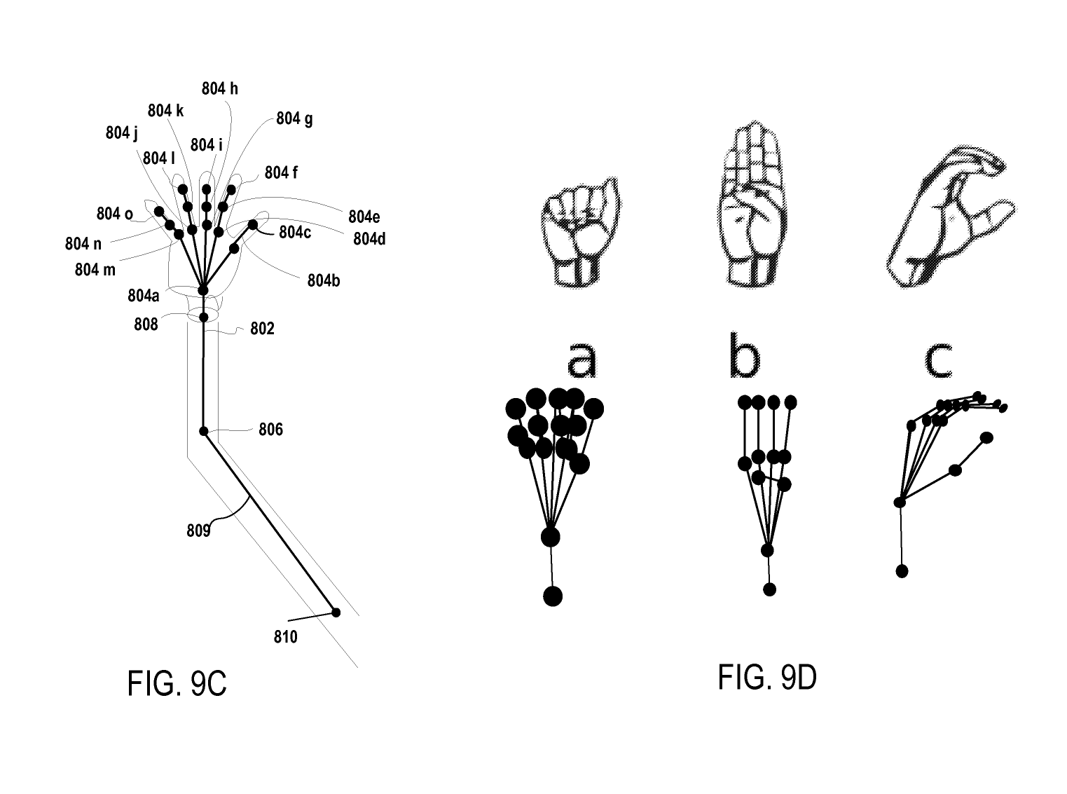

FIG. 9A depicts an example skeletal mapping of a user that may be generated from image data captured by the capture device 20 in the manner described above. In this example, a variety of joints and bones are identified: each hand 402, each forearm 404, each elbow 406, each bicep 408, each shoulder 410, each hip 412, each thigh 414, each knee 416, each foreleg 418, each foot 420, the head 422, the torso 424, the top 426 and bottom 428 of the spine, and the waist 430. Where more points are tracked, additional features may be identified, such as the bones and joints of the fingers or toes, or individual features of the face, such as the nose and eyes.

In a model example including two or more body parts, each body part of the model may comprise one or more structural members (i.e., “bones”), with joints located at the intersection of adjacent bones. For example, measurement values determined by the bitmask may be used to define one or more joints in a skeletal model. The one or more joints may be used to define one or more bones that may correspond to a body part of a human. Each joint may allow one or more body parts to move relative to one or more other body parts. For example, a model representing a human target may include a plurality of rigid and/or deformable body parts, wherein some body parts may represent a corresponding anatomical body part of the human target. Each body part may be characterized as a mathematical vector defining joints and bones of the skeletal model. It is to be understood that some bones may correspond to anatomical bones in a human target and/or some bones may not have corresponding anatomical bones in the human target.

As the user moves in physical space, as captured by capture device 20, the resultant image data may be used to adjust the skeletal model such that the skeletal model may accurately represent the user. According to an example embodiment, the model can be rasterized into a synthesized depth image by the depth image processing software 450. Rasterization allows the model described by mathematical vectors, polygonal meshes, or other objects to be converted into a synthesized depth image described in terms of pixels. Differences between an observed image of the target, as retrieved by a capture system, and a rasterized (i.e., synthesized) image of the model may be used to determine the force vectors that are applied to the model in order to adjust the body into a different pose. In one embodiment, one or more force vectors may be applied to one or more force-receiving aspects of a model to adjust the model into a pose that more closely corresponds to the pose of the target in the physical space of the capture area. The model may be iteratively adjusted as frames are captured. Depending on the type of model that is being used, the force vector may be applied to a joint, a centroid of a body part, a vertex of a triangle, or any other suitable force-receiving aspect of the model. Furthermore, in some embodiments, two or more different calculations may be used when determining the direction and/or magnitude of the force.

In one or more embodiments for capturing a user's natural movements, the capture device 20 repeatedly sends data for motion tracking to the computing system 12. The motion tracking data may include data referenced with respect to some form of a skeletal model such as vectors with respect to different joints, centroids or nodes to illustrate movement changes. The data may be referenced to a synthesized pixel data representation created from rasterizing the vector data. The data may also include a bitmask of the user for comparison on each update to detect which body parts are moving. Each body part is indexed so it can be identified, other parts of the capture area such as the furniture in the living room are identified as background, and the users are indexed so the machine representable data for their respective body parts can be linked to them.

The depth image processing and skeleton tracking 450 can use indices to identify to the gesture recognition engine 454 which body parts have changed position between updates. For different body parts, there are associated gesture filters 456 which the engine 454 may apply. A filter 456 may comprise code and associated data that can recognize gestures or otherwise process depth, RGB, or skeletal data. For example, the filter code instructions may process depth values, or vectors with respect to the skeletal data, or color image data or a combination of two or more of these when determining whether the parameter criteria for a gesture is satisfied. In other words, a gesture filter 456 includes instructions for determining whether the movements indicated in the update or a series of updates represents a gesture, which can be a movement itself or a resulting pose.

Marketing terms can be associated with different gestures so the advertisement application 198 receives a message from the gesture recognition engine 454, or in some cases the application 452, when a gesture for a marketing term has been expressed so the application 198 can update the term context data including the count based on the notice. The application 198 may receive a confidence level that the gesture occurred from the engine 454, and may decide whether to update the count or not based on the confidence level.

In one embodiment, a gesture filter 456 executes instructions comparing motion tracking data for one or more body parts involved with the gesture with parameters including criteria relating to motion characteristics which define the gesture. A filter need not have a parameter. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Some examples of motion characteristics include position, shape, angle, speed and acceleration changes in one or more body parts as well as configuration, orientation, position and movement. For instance, a throw, may be implemented as a gesture comprising information representing the movement of one of the hands of the user from behind the rear of the body to past the front of the body, as that movement would be captured by a depth camera. Some examples of a parameter for the “throw” may be a threshold velocity that the hand has to reach, a distance the hand must travel (either absolute, or relative to the size of the user as a whole), and a direction of movement of the hand from behind the body to past its front. The parameters can be stored as metadata for its corresponding gesture. A parameter may comprise any of a wide variety of motion characteristics for a gesture. Where the filter comprises a parameter, the parameter value can take different forms, for example, it may be a threshold, an absolute value, a fault tolerance or a range.

Some more examples of motion characteristics that may be represented by parameters are as follows: body parts involved in the gesture, angles of motion with respect to a body part, a joint, other body parts or a center of gravity of the user's body as represented by his skeletal model, changes in position of a body part or whole body, and distances moved by a body part or whole body. Additionally, other examples of characteristics are a location of a volume of space around the user's body in which a body part moves, a direction of movement, a velocity of movement of a body part, a place where a movement occurs, an angle between a body part and another object in the scene, an acceleration threshold, the time period of the gesture, the specific time of the gesture, a release point, threshold angles (e.g., hip-thigh angle, forearm-bicep angle, etc.), a number of periods where motion occurs or does not occur, a threshold period, threshold position (starting, ending), direction movement, velocity, acceleration, coordination of movement, etc. In an embodiment, the user also uses his voice to make, augment, distinguish or clarify a gesture.

The input data may be presented as changes occur in position, speed, direction of movement, joint angle etc. with a previous positioning data set for the one or more body parts involved in the gesture. The gesture recognition engine 454 may implement an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

There are a variety of outputs that may be associated with the gesture. There may be a baseline “yes or no” as to whether a gesture is occurring. There also may be a confidence level, which corresponds to the likelihood that the user's tracked movement corresponds to the gesture.

A particular type of gesture which may be expressive of a marketing term is a sign of a sign language. FIG. 2B illustrates one embodiment of a gesture recognition engine 454 including a sign language interpreter 180 in which embodiments of the technology may operate.

In FIG. 2B, illustrated is an embodiment of the gesture recognition engine 454 including a sign language interpreter 180. In one embodiment, the gesture recognition engine 454 may comprise, for example, a skeletal extraction component 192, a motion tracker 196, a registration component 194, a face classifier 198, and a hand classifier 199 as well as gesture filters 456. The skeletal extraction component 192 may function as discussed above and/or in accordance with U.S. patent application Ser. No. 12/475,094 “Environment and/or Target Segmentation” filed May 29, 2009, Mathe et al., incorporated herein by reference in its entirety, to extract and define a skeletal system to track user motion. Examples of skeletal systems are illustrated in FIGS. 9A-9D. In one embodiment, the motion tracker component 196 operates in conjunction with the disclosure of the '437 Application to track the motion of the detected skeleton within a scene. Motions and gesture components are translated into gestures by applying gesture filters 456, and the recognized gestures are matched against a lexicon library 193 of known signs including those for marketing terms. Gesture components include, but are not limited to: hand shape and configuration relative to a user's body and other hand; finger shape and configuration relative to a user's hand, other fingers and body; hand and finger orientation (e.g. up, down, sideways); hand, finger arm and head movement including the beginning and ending positions of the movement relative to other hand, finger, arm and body positions (e.g. across the chest, off to the side, etc.).

The registration component 194 synchronizes the information provided by the components 24, 26, 28, 40, of capture device 20. Information from the capture device may, as discussed above, include depth and image information. Registration component 194 synchronizes this information to detect gesture movement, for example, as per the discussion above with respect to FIG. 2A. For the embodiment of FIG. 2B, the camera resolution of capture device 20 is capable of distinguishing individual finger movements.

Face classifier 198 and hand classifier 199 detect fine-grained changes in a user's hand and face, hand and finger shape as well as configuration, orientation, position and movement, all of which can affect the interpretation of a gesture as described below. Detection of face expression and individual digit movements of a hand may be relevant to the interpretation of a gesture as a sign. Face classifier 198 and hand classifier 199 work in conjunction with skeletal extraction component 192, and the motion tracker 196. In some embodiments, the face classifier 198 may be part of the facial recognition engine code 492 which works in conjunction with the gesture recognition engine code 454. The skeletal extraction component 192 and motion tracker 196 inform the face classifier 198 and hand classifier 199 where the hands and face are located in the scene so that the hand and face classifiers are not burdened with determining that for themselves. The skeletal extraction component 192 also uniquely identifies each user so that each user's sign language conversations can be tracked independently.

Where the resolution of the capture device 20 is sufficient to provide tracking of a model of a hand or face, face classifier 198 and hand classifier 199 determine positions of the users face and hands based on motions of the face and hands that add information to the matching algorithm of a lexicon/grammar matcher 195, both of which detect the user 18 in a scene based on the information provided by the capture device 20 to provide a sign language output 188. The lexicon/grammer matcher 195 may include a lexicon dictionary 193, user data 186 and a grammar library 185. When a gesture is detected, the information is fed to the lexicon/grammar matcher 195 which consults the dictionary 193 and compares detected motions to those stored in the dictionary to determine the meaning of particular signs provided by the user. The lexicon dictionary 193 includes signs for the marketing terms. In addition, signs assigned to gestures are compared to the grammar library 185 and user data 186 to verify the accuracy of the assignment of the sign to the gesture. The grammar library 185 contains information on whether any sign makes sense in light of preceding and succeeding signs. User data 186 contains user specific demographics and other user-specific information used to determine if the sign makes sense in view of specific known user information.

FIG. 9B illustrates a more fine-grained tracking model used in conjunction with classification of signs made by a hand and arms. A user performing the gesture for “PAY” is illustrated in the left hand side of FIG. 9B. “PAY” may be a marketing term for financial services products like online payment services (e.g. PayPal®), and credit and debit card offers. A corresponding tracking model 470 is illustrated adjacent to the user depicted. The model in FIG. 9B has a higher resolution than the model illustrated in FIG. 9A. The model in FIG. 9B includes elements for a user hand 480, wrist 481, and elbow 483 of the user's right limb and corresponding elements 484-486 for a left limb. As illustrated therein, when a user moves hand 518 along the motion of line 519, the corresponding motion is tracked for at least points 480 (from 480a to 480b), 481 (from 481a to 481b), and 483 (from 483a to 483b).

FIGS. 9C and 9D illustrate a tracking model used with the signs of the hand. In FIG. 9C, a model may include at least points 804a-804m for a hand of a user, as well as a wrist point 808, elbow 806, forearm 802, upper arm 809 and shoulder 810. FIG. 9D illustrates the hand model 804 of FIG. 9C showing gestures for the letters “a”, “b”, and “c” using American Sign Language (ASL) conventions. (Reference numerals omitted in FIG. 9D for clarity.)

One suitable example of interpreting gestures as sign gestures is provided in U.S. patent application Ser. No. 12/794,455, “Machine Based Sign Language Interpreter” filed on Jul. 28, 2010, Tardif, incorporated herein by reference in its entirety.

Embodiments of the technology provide for automatically generating an advertisement based on a real-time live speech expression of a marketing term. A marketing term may be one or more words which may be linked to a product or service. A generic term representing a category of goods or services like soap, drink, shoe, pants, pizza, iced tea, necklace may be a marketing term. A term representing a user state of mind or physical feeling like thirsty or hungry may be a marketing term. Other marketing terms may be name brands like Coke®, Mountain Dew® or the title of a particular movie or book.

The marketing terms are downloaded to a datastore 190, for ease of reference described in FIG. 2A as marketing term advertisement datastore 190, from a datastore 195, also named for ease of description, marketing term advertisement datastore 195 which is updated by the advertisement software application 194 executing on the remote computer system 208 communicatively coupled over the Internet, or other network, 50 to computing system 12 and other computer systems 213. The datastore 195 may link each marketing term to one or more advertisements. For example, for the marketing term “drink”, advertisements for various soft drink brands may be linked to the term. The datastore 190 stored by the computing system 12 may mirror or, more likely include a subset of the advertisements linked to each marketing term, and perhaps a subset of the marketing terms. An implementation example of a datastore is a database.

The advertisement application 194 on the remote computer system may link an advertisement with a marketing term in datastore 195 based on demographics data stored in a demographics datastore 191. In some embodiments, the demographics datastore 191 is a non-identifying demographics database. In other embodiments, in which the remote computer system 208 has access to identifying user profile data. demographics database 191 may be linked to identifying information in user profile data stored in a memory of the remote computer system 208. For example, the user profiles may be for all users registered with a gaming service like Xbox Kinect®.

The advertisement customization module 196 comprises software for updating one or more counts associated with detected expressions of a marketing term, in this example, advertisement application 198. The one or more counts are part of term context data for each term. A non-identifying portion of the term context data may be transmitted to the advertisement application 194 of the remote computer system 208. A count of a marketing term is transmitted so as not to violate the privacy of the users as the term is not presented in context of the conversation or speech the user was making. The count may be with respect to a time period of an execution instance of a multimedia application such as a game. The term context data may also include an identifier of the application during which the term was expressed, one or more time intervals between the term being expressed during an execution instance of the multimedia application (e.g. game), which other users were present online or in the vicinity of the audio capture device or audiovisual capture device, non-identifying demographic data for these other users, or simply whether the user was alone or not when the term was expressed, and the location of the user when the user expressed the term. For example, whether the user is playing a game on her home machine or at a friend's house may be determined by the IP address of the computer on which she is playing the game.

In some embodiments, the remote computer system 208 may be under the control of a third party which provides advertisements, performs market research or both. Non-identifying term context data may be provided to such a third party system which may identify an advertisement to be displayed for a designated, yet not identified, user based on the non-identifying user profile data presented in the term context data. In other instances, the remote computer system 208 may be under the control of a gaming service or other content provider which has access to the user's identifying information already, for example as a result of providing online gaming services directly to users or the users have consented to use of their user profile data by the gaming service. Besides directly generating advertisements, the advertisement application 194 on either type of remote computer system may generate marketing research reports based on the marketing term counts and the demographic data of the term context data.

In one or more embodiments, capture device 20 initially captures one or more users in its field of view and provides a visual image of the captured one or more users to the computing system 12. Computing system 12 performs the identification of the users captured by the capture device 20. In one embodiment, computing system 12 includes a facial recognition engine 492 to perform the identification of the users. Facial recognition engine 492 may correlate a user's face from the visual image received from the capture device 20 with a reference visual image to determine the user's identity. In another example, the user's identity may be also determined by receiving input from the user identifying their identity. In one embodiment, users may be asked to identify themselves by standing in front of the computing system 12 so that the capture device 20 may capture depth images and visual images for each user. For example, a user may be asked to stand in front of the capture device 20, turn around, and make various poses. After the computing system 12 obtains data necessary to identify a user, the user is provided with a unique identifier and password identifying the user. More information about identifying users can be found in U.S. patent application Ser. No. 12/696,282, “Visual Based Identity Tracking” and U.S. patent application Ser. No. 12/475,308, “Device for Identifying and Tracking Multiple Humans over Time,” both of which are incorporated herein by reference in their entirety. In another embodiment, the user's identity may already be known by the computing system when the user logs into the computing system 12.

In one embodiment, the user's identification information may be stored in a user profile datastore 197 in the computing system 12. The user profile database 197 may include information about the user such as a unique identifier and password associated with the user, the user's name and other demographic information related to the user. Examples of such user profile data are the user's age group, gender, geographical location, in one example the user's zip code, games played, the user's statistics for particular games, gamer category (e.g. family, hard-core, casual), other users the user has played with and how often the user has played with each, the user's friends' list (which may be optionally provided by the user), the user's stated preferred activities, features of the user's avatar such as clothing, hair color, eye color and other physical attributes, and other multimedia content viewed by the user on the computing system 12 or other computer system where the user was identified as a viewer. In one embodiment, computing system 12 may automatically track user profile data related to one or more of the users detected by the capture device 20.

In some embodiments, the disclosed technology may provide a mechanism by which a user's privacy concerns are met by protecting, encrypting or anonymizing some or all of the user profile data before implementing the disclosed technology. The disclosed technology may also provide a mechanism by which a user's privacy concerns are met by obtaining a user's consent prior to the gathering of the user-specific information, via a user opt-in process before implementing the disclosed technology.

In some embodiments, capture device 20 may capture audio data and visual images, for example visual images of sign language gestures, of one or more users in a field of view of the capture device 20 to determine whether an expression of a marketing term has been made while multimedia content is being displayed by the audiovisual device 16 connected to the computing system 12. In another embodiment, speech recognition software 458 processes streamed audio data generated from live audio signals captured by microphone 40 for detecting whether a marketing term has been expressed in audible speech.

Responsive to a marketing term being detected, the advertisement application 198 identifies an advertisement based on the term context data for the marketing term expression instance, and causes the identified advertisement to be communicated to one or more designated users. One example of communicating the identified advertisement is including the advertisement within a scene of multimedia content being displayed on a display like audiovisual device 16 for the designated user by an executing application 452 such as a game application. For example, if the terms “drink” and “thirsty” are detected, and based on the user's age demographic data, an iced tea advertisement may be displayed for a person in the over 35 age group, and a Coke advertisement displayed for a male in the under 35 age group.

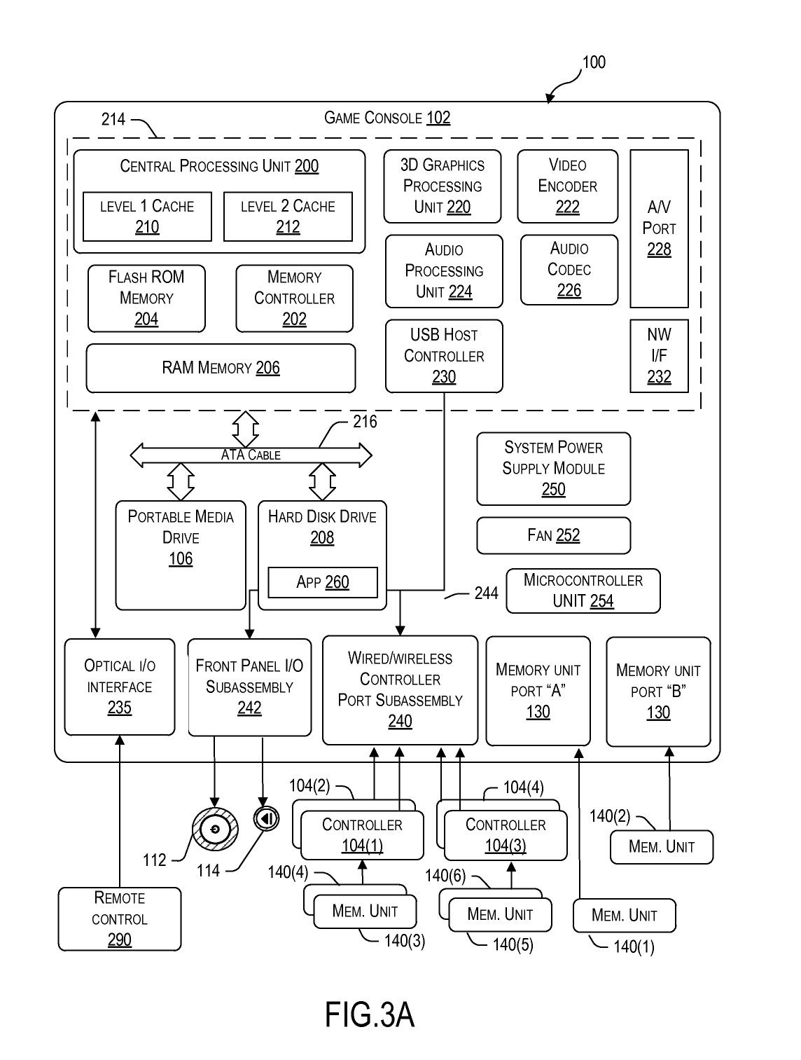

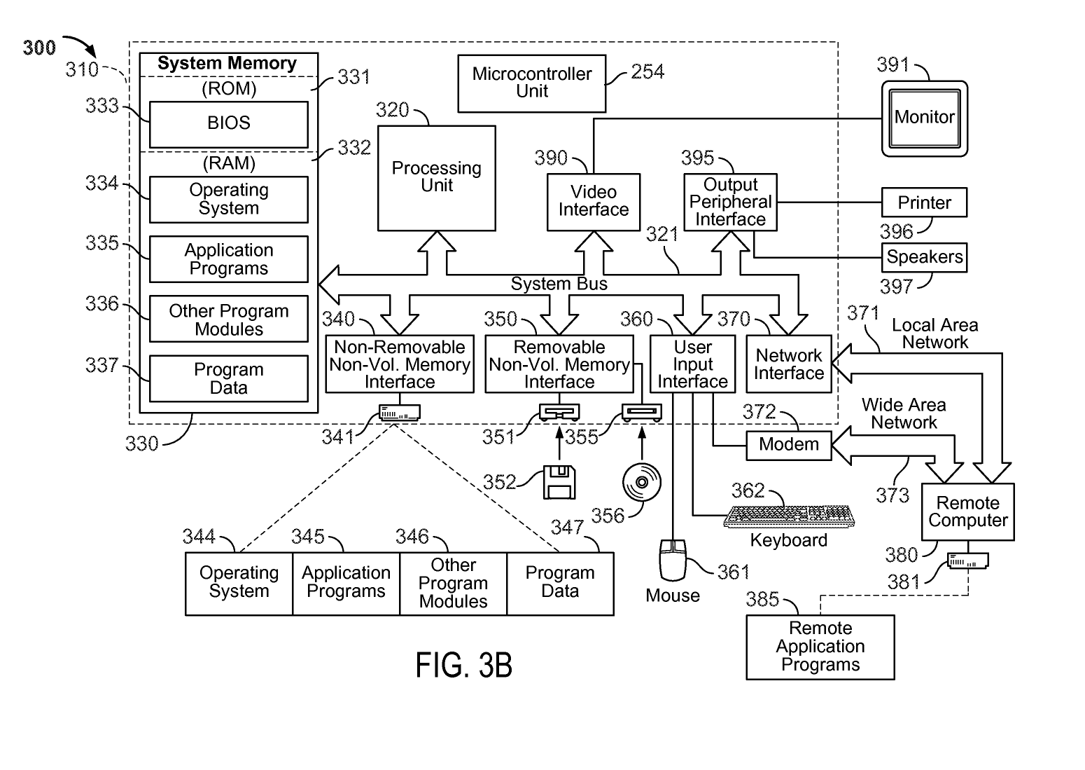

FIG. 3A illustrates an example of a computing system 100 that may be used to implement the computing system 12 of FIGS. 1-2B. In one embodiment, the computing system 100 of FIG. 3A may be a multimedia console 100, such as a gaming console. As shown in FIG. 3A, the multimedia console 100 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A graphics processing unit 220 and a video encoder 222 form a video processing pipeline for high speed and high resolution (e.g., High Definition) graphics processing. Data are carried from graphics processing unit (GPU) 220 to video encoder 222 via a digital video bus (not shown). Lightweight messages generated by the system applications (e.g., pop ups) and advertisements selected by the advertisement application 198 are displayed by using a GPU 220 interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 3A shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 3A, console 102 includes a controller support subassembly 240 for supporting four controllers 104(1)-104(4). The controller support subassembly 240 includes any hardware and software components needed to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202. A system power supply module 250 provides power to the components of gaming system 100. A fan 252 cools the circuitry within console 102.

An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 100 may be operated as a standalone system by simply connecting the system to monitor 150 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community.

FIG. 3B illustrates a general purpose computing system which can be used to implement another embodiment of computing system 12 or remote computer system 208. With reference to FIG. 3B, an exemplary system for implementing embodiments of the disclosed technology includes a general purpose computing system in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3B illustrates operating system 334, application programs 335, other program modules 336, and program data 337.

The computer 310 may also include other removable/non-removable, volatile/nonvolatile computer storage media. By way of example only, FIG. 3B illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3B, provide storage of computer readable instructions, data structures, program modules and other data for the computer 310. In FIG. 3B, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3B. The logical connections depicted in FIG. 3B include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3B illustrates remote application programs 385 as residing on memory device 381. It will be appreciated that the network connections shown are exemplary and other means of establishing a communications link between the computers may be used.

The example computer systems illustrated in FIGS. 1 through 3B include examples of computer readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

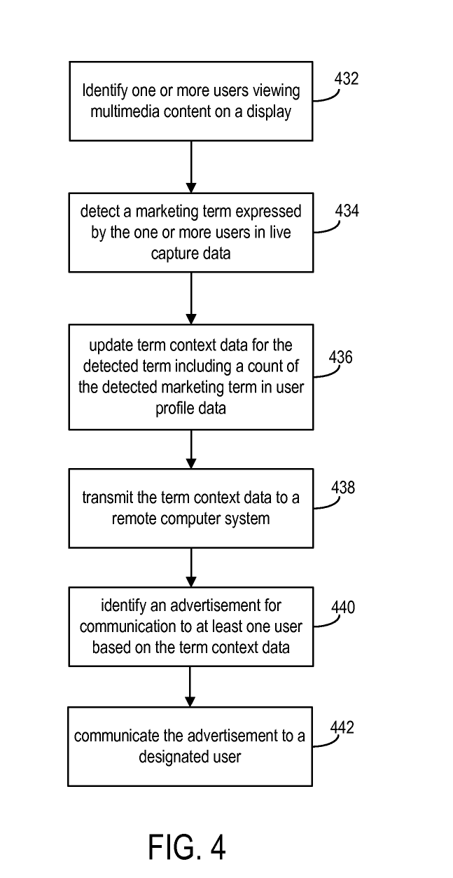

The hardware devices of FIGS. 1-3B discussed above can be used to implement one or more embodiments of a system for generating an advertisement for one or more users based on user expression of a marketing term captured while viewing multimedia content. FIGS. 4 through 8B illustrate one or more processes that may be used in embodiments of a method for generating an advertisement for one or more users based on user expression of a marketing term captured while viewing multimedia content. The method embodiments are discussed with reference to the hardware and software components described in FIGS. 1-3B for illustration. The method embodiments can operate in other system configurations as well.

FIG. 4 is a flowchart describing one embodiment of a method for generating an advertisement for one or more users based on user expression of a marketing term captured while viewing multimedia content. In step 432, an application (e.g. 492 or 452) executing on the computer system 12 identifies one or more users viewing multimedia content on a display like audiovisual device 16. The speech recognition software 458 or the gesture recognition engine 454 in step 434 detects a marketing term expressed by the one or more users in live capture data, for example from an audiovisual capture device (e.g. capture device 20). The advertisement application 198 updates in step 436 term context data for the detected term including a count of the detected marketing term in user profile data and transmits the term context data to a remote computer system in step 438. For example, the remote computer system may be a third party marketing system or an intervening remote computer system (e.g. content provider) which interfaces with the third party marketing system. Based on the term context data, the advertisement application 198 identifies an advertisement for communication to at least one user based on the term context data and causes the computing system 12 to communicate the advertisement to a designated user in step 442. For example, the advertisement may be sent to an e-mail address of the designated user or displayed within a scene of the executing multimedia application.

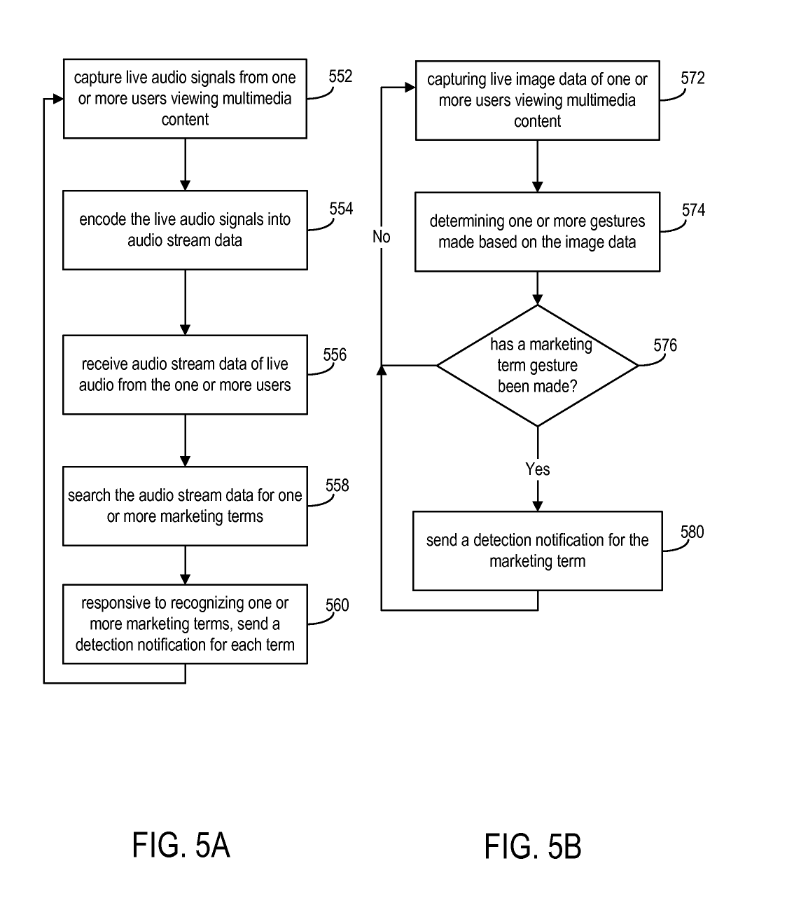

The steps of the method embodiment of FIG. 4 and the implementation process examples in FIGS. 5A to 8B may also be performed by a remote computer system which may be under the control of a gaming service or other content provider executing a multimedia application 452 for one or more remote users at one or more communicatively coupled computer systems 213 to which audiovisual capture 20 and audiovisual display devices 16 are locally coupled. The one or more local systems 213 may send the live audio streams and image data to the remote computer system for detection of marketing terms. Furthermore, the processing may be shared between a computing system (e.g. 12) local to the user and a remote computer system (e.g. 208) such as that controlled by a gaming service. For example, detection of marketing terms may be done locally while selection of an advertisement and/or communication of the advertisement may be done at the remote system.

FIG. 5A is a flowchart describing one embodiment of an implementation process for detecting a marketing term expressed by the one or more users in live capture data. Microphone 40 can capture live audio signals from one or more users viewing multimedia content in step 552, and audio processing unit 224, the audio codec 226 or both encode the live audio signals into audio stream data in step 554. The speech recognition software 458 receives the audio stream data of live audio from the one or more users in step 556 and searches the audio stream data for one or more marketing terms in step 558. Responsive to recognizing one or more marketing terms, the speech recognition software 458 sends a detection notification for each detected term to the advertisement application 198. The process of searching for marketing terms continues and repeats for a period of time, or until the instance of multimedia executions ends or the microphone is turned off or some other marketing term searching session end criteria.

FIG. 5B is a flowchart describing one embodiment of another implementation process for detecting a marketing term expressed by the one or more users in live capture data. In step 572, the image capture device 20 captures live image data of one or more users viewing multimedia content, and the gesture recognition engine 454 determines one or more gestures made based on the image data in step 574. The gesture engine 454 determines whether a gesture for a marketing term has been made in step 576. An example of such a gesture is a sign gesture. If not, processing continues as more image data is captured. If so, the gesture engine 454 sends a detection notification for the marketing term to the advertisement application 198 in step 580 and processing continues as more image data is captured.

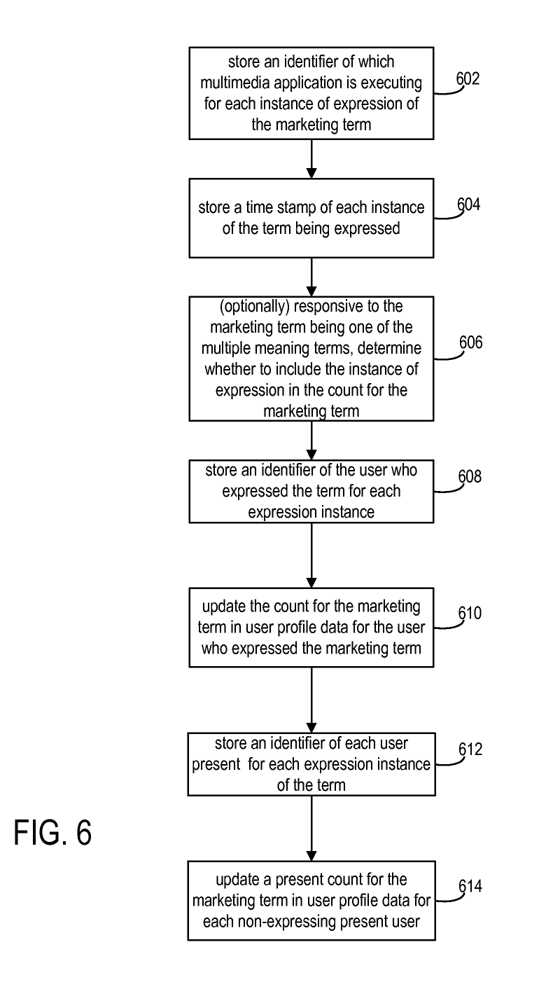

FIG. 6 is a flowchart describing one embodiment of an implementation process for updating term context data for a detected term. The advertisement application 198 in step 602 stores an identifier of which multimedia application is executing for each instance of expression of the marketing term and also stores a time stamp of each instance of the term being expressed in step 604.

Some marketing terms may have another meaning not related to the meaning of the marketing term. For example, Nike® brand shoes are not the same as Nike, the name of the Greek goddess of victory. The marketing term advertisement datastore 190 may include secondary words linked to a marketing term. The secondary words are identified if detected in the speech expressions as well. If the linked marketing term is expressed as well, step 606 may be performed. Some embodiments may count all occurrences of a marketing term without distinguishing from among multiple meanings.

Optionally, responsive to the marketing term being a multiple meaning term, the advertisement application 198 determines whether to include the instance of expression in the count for the marketing term in step 606. Some examples of criteria upon which the advertisement application may make the determination include secondary words expressed within a time period of the expressed term, demographic data from user profile data for the user who expressed the term, and demographic data from user profile data for other users present when the user expressed the term.

In step 608, the advertisement application 198 stores an identifier of the user who expressed the term for each expression instance of the term and updates the count for the marketing term in user profile data for the user who expressed the marketing term in step 610. In step 612, the advertisement application 198 stores an identifier of each user present for each expression instance of the term, and in step 614, updates a present count for the marketing term in user profile data for each non-expressing present user. This present count may be used by the application 198 to select an advertisement suitable for the user and the other users present, for example, if the other users are children. In another example, an advertisement may be selected for the type of product, say a drink, this user has mentioned before in other games played with these users. For example, when playing with his wife, a user may have mentioned in one or more previous instances “drink” and “iced tea.” When playing with other males of the same age, “drink” and the brand name “Mountain Dew®” have been mentioned.

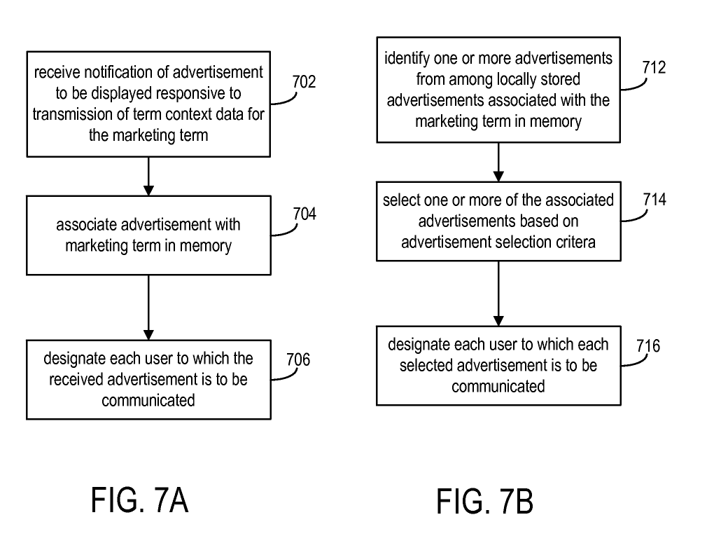

FIG. 7A is a flowchart describing one embodiment of an implementation process for identifying an advertisement for communication to at least one user based on the term context data. In step 702, the advertisement application 198 receives notification of advertisement to be displayed responsive to transmission of term context data for the marketing term. The advertisement application 194 on the remote computer system 208, for example a third party marketing service remote computer system, selects the advertisement in this example. In step 704, the advertisement application 198 associates the received advertisement with the marketing term in the local memory datastore 190. In step 706, the advertisement application 198 designates each user to which the received advertisement is to be communicated.

FIG. 7B is a flowchart describing another embodiment of an implementation process for identifying an advertisement for communication to at least one user based on the term context data. In step 712, the advertisement application 198 identifies one or more advertisements from among locally stored advertisements (e.g. 190) associated with the marketing term in memory, and selects in step 714 one or more of the associated advertisements based on advertisement selection criteria. Some examples of advertisement selection criteria are a count of the number of times a marketing term is expressed in a certain time period by one or more users, a count of the number of times a user has expressed the term, the demographics of those users in the vicinity of one or more audiovisual input devices, one or more time intervals, as may be indicated by the time stamps, between the term being expressed during an instance of execution of a multimedia application, one or more time intervals between the term being expressed by each user during an instance of execution of a multimedia application, whether the user is alone when the term is expressed and the geographic location of the user when the term is expressed, and whether the user is interacting within the vicinity of an audiovisual capture device where there is an expectation of privacy for the speech of the user.

An advertisement of a merchant location may be selected based on geographic location data in the user profiles of one or more users interacting with a multimedia application when the term was expressed. An advertisement of a merchant location may be selected based on geographic location data of the computer system on which a multimedia application is executing. For example, the IP address of the computer system may be linked with geographic data in one or more user profiles of users who play on that computer system.

In step 716, the advertisement application 198 designates each user to which each selected advertisement is to be communicated.

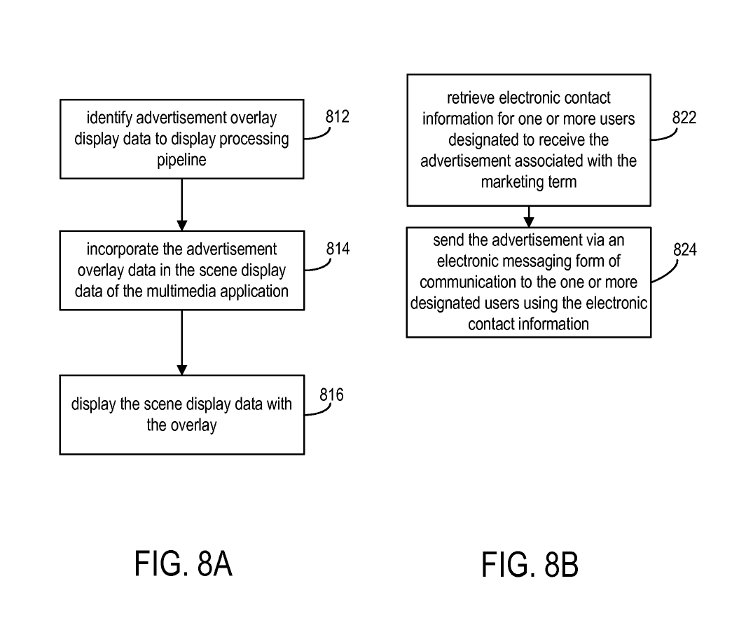

FIG. 8A is a flowchart describing one embodiment of an implementation process for communicating an advertisement to a designated user. In step 812, the advertisement application 198 identifies advertisement overlay display data to a display processing pipeline. An example of such a pipeline is the 3D graphics processing unit 220 and the video encoder 222. The graphics processing unit 220 may send an interrupt to the video encoder 222 schedule code to render the advertisement into an overlay. The amount of memory required for an overlay depends on the overlay area size and the overlay preferably scales with screen resolution. The publisher of a multimedia application such as a game may identify certain screen objects which may be overlaid with an advertisement. In some instances, these objects are similar to real life objects which would have an advertisement like a billboard or a drink dispensing machine, or cans at a bar as in a scene in a virtual world such as SecondLife® In step 814, the video encoder 222 incorporates the advertisement overlay data in the scene display data of the multimedia application, and the display data is sent to the AV port 228 to an audiovisual display device 16 or over a network interface 232 to a remote display device or both as may arise in an online game. The scene display data is displayed with the overlay in step 816.

Similarly, the advertisement application 198 identifies advertisement overlay audio data to an audio processing pipeline such as that including an audio processing unit 224 and an audio codec (coder/decoder) 226 for multi-channel audio processing of various digital audio formats. Using an interrupt as well, the CPU 200 or GPU 220 may schedule code to render an audio advertisement into an audio overlay or patch to replace a marketing term spoken by a game or multimedia character as designated by the multimedia application developer.

FIG. 8B is a flowchart describing another embodiment of an implementation process for communicating an advertisement to a designated user. In step 822, the advertisement application 198 retrieves electronic contact information for one or more users designated to receive the advertisement associated with the marketing term and in step 824, sends the advertisement over a network interface 371, 373, 232 in an electronic messaging form of communication to the one or more designated users using the electronic contact information. For example, a user may be sent an e-mail or a “Tweet” on Twitter® with the advertisement. Other social networking and wireless based communication formats such as text messaging may also be used.

The technology may be embodied in other specific forms without departing from the spirit or essential characteristics thereof. Likewise, the particular naming and division of modules, routines, features, attributes, methodologies and other aspects are not mandatory, and the mechanisms that implement the technology or its features may have different names, divisions and/or formats. Furthermore, as will be apparent to one of ordinary skill in the relevant art, the modules, routines, features, attributes, methodologies and other aspects of the embodiments disclosed can be implemented as software, hardware, firmware or any combination of the three. Of course, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for generating an advertisement for one or more users based on user expression of a marketing term captured while viewing multimedia content comprising:
identifying one or more users viewing the multimedia content on a display communicatively coupled to a computer system;
detecting the marketing term expressed by the one or more users in live capture data;
updating term context data including a count of the number of times the marketing term has been expressed by the one or more users;
transmitting the term context data including the count to a remote computer system;
identifying an advertisement based on the term context data for communication to one or more designated users; and
communicating the advertisement to the one or more designated users.

2. The computer-implemented method of claim 1 wherein
detecting the marketing term expressed by a user in capture data from an audiovisual capture device communicatively coupled to a computer system further comprises
detecting the marketing term in live audio data received via an audio input device communicatively coupled to the computer system.

3. The method of claim 1 wherein:
communicating the advertisement to the one or more designated users further comprises displaying an advertisement on the audiovisual device responsive to detecting the marketing term.

4. The method of claim 3 wherein:
displaying an advertisement on the audiovisual device responsive to detecting the marketing term further comprises:
displaying the advertisement within an executing game application.

5. The method of claim 2, wherein:
the detecting the marketing term in audio data received via the audio device communicatively coupled to the computer system further comprises a processor under the control of speech recognition software identifying the marketing term based on one or more marketing terms stored in the memory.

6. The method of claim 1, wherein the term context data further comprises non-identifying demographic data from the user profile of the user who expressed the marketing term.

7. The method of claim 6, wherein:
transmitting the term context data including the count to the remote computer system further comprises
transmitting non-identifying demographic data from the user profile of the user who expressed the marketing term to the remote computer system; and
transmitting non-identifying demographic data of any other users having user profiles present in a time period in which the marketing term was expressed to the remote computer system.

8. The method of claim 1, wherein the term context data further comprises at least one of the group consisting of the following:
whether the term was expressed during a game;
one or more time intervals between the term being expressed during an instance of execution of a multimedia application;
one or more time intervals between the term being expressed by each user during an instance of execution of a multimedia application;
which other users were present in the vicinity when the term was expressed;
whether the user was alone when the term was expressed; and
the location of the user when the user expressed the term.

9. The method of claim 1, wherein:
updating term context data including a count of the number of times the marketing term has been expressed by the one or more users further comprises:
determining whether the term expressed has the meaning of the marketing term based on term context data.

10. The method of claim 9, wherein:
the term context data used as a basis for determining whether the term expressed has the meaning of the marketing term is one of the group consisting of:
secondary words expressed within in a time period of the term spoken;
demographic data from user profile data for the user who expressed the term; and
demographic data from user profile data for other users present when the user expressed the term.

11. The method of claim 1, wherein:
detecting the marketing term expressed by the one or more users in live capture data from the audiovisual capture device communicatively coupled to the computer system further comprises
detecting the marketing term in a sign gesture captured via an image capture device of the audiovisual capture device communicatively coupled to the computer system.

12. A computer-implemented system for generating an advertisement for one or more users based on user expression of a marketing term comprising:
an audio input device communicatively coupled to a multimedia computer system to receive live audio signals from the one or more users in the vicinity of the audio device;
the vicinity of the audio device is a location where the one or more users has an expectation of privacy;
the multimedia computer system being communicatively coupled to a remote computer system for receiving one or more marketing terms from the remote system and for sending term context data to the remote computer system;
the multimedia computer system having a memory for storing the one or more marketing terms and a user profile for each respective user of a multimedia application;
the memory storing speech recognition software for receiving audio stream data of the live audio signals and for identifying whether the one or more marketing terms have been spoken in the audio stream data;
a processor of the multimedia computer system updating term context data in the memory, the term context data including a count for each marketing term of the number of times the term was spoken during execution of a multimedia application; and
the processor causing display of an advertisement based on the term context data

13. The system of claim 12 further comprising:
software stored in the memory which when executing on the processor retrieves non-identifying demographics data from the user profile of each user who spoke the marketing term and sends the non-identifying demographics data in the term context data.

14. The system of claim 12 further comprising:
the processor under the control of software receives video data including an advertisement from the remote computer system to display within the executing multimedia application; and
the processor updates the executing application to include the video data including the advertisement.

15. One or more computer storage media having stored thereon instructions which when executed by a processor cause the processor to perform a method for generating an advertisement for one or more users based on user expression of a marketing term, the method comprising:
detecting a marketing term in streaming audio data representing real-time speech received via an audio input device communicatively coupled to a computer system with a display;
updating a count of the marketing term in a user profile of a user in a vicinity of the audio device when the term was spoken, the user profile being stored in a memory of the computer system;
transmitting term context data including the count of the marketing term to a remote computer system; and
communicating an advertisement to one or more users based on the term context data.

16. The one or more computer storage media of claim 15 wherein communicating the advertisement to one or more users based on the term context data further comprises:
displaying an advertisement on the display in real-time responsive to detecting the marketing term.

17. The one or more computer storage media of claim 16 wherein displaying an advertisement on the display in real-time responsive to detecting the marketing term further comprises:
displaying an advertisement of a merchant location based on geographic location data in the user profiles of one or more users interacting with a multimedia application when the term was spoken.

18. The one or more computer storage media of claim 17 wherein displaying an advertisement on the display in real-time responsive to detecting the marketing term further comprises:
displaying an advertisement of a merchant location based on geographic location data of the computer system on which a multimedia application is executing, the geographic data being determined based on geographic data from the user profiles of one or more users interacting with the multimedia application when the term was spoken.

19. The one or more computer storage media of claim 16 wherein communicating an advertisement to the one or more users based on the term context data further comprises:
sending an advertisement to the user based on the term context data via an electronic messaging form of communication based on electronic contact information in the user profile of the user.

20. The one or more computer storage media of claim 19 wherein the user communicating an advertisement to the one or more users based on the term context data further comprises:
sending an advertisement to another user of the one or more users linked to the profile of the user who spoke the term but who was not present when the term was spoken based on term context data of the term spoken by the user.
